(19) United States
(12) Patent Application Publication
(10) Pub. No.: US 2011/0287329 A1
(43) Pub. Date: Nov. 24, 2011

(54) AIR BATTERY

(75) Inventors: Fuminori Mizuno, Toyota-shi (JP); Shinji Nakanishi, Shizuoka-ken (JP)

(73) Assignee: TOYOTA JIDOSHA KABUSHIKI KAISHA, Toyota-shi, Aichi-ken (JP)

(21) Appl. No.: 13/146,143

(22) PCT Filed: Mar. 6, 2009
(86) PCT No.: PCT/JP2009/054262

§ 371 Date: Jul. 25, 2011

(51) Int. Cl. H01M 8/22

(52) U.S. Cl. 429/407; 429/403

(57) ABSTRACT

The present invention provides an air battery which is capable of detecting entering of water at an early point. The air battery comprising: a power section which comprises an air electrode to which an oxygen-containing gas is supplied, an anode containing an alkali metal, and an electrolyte layer containing an electrolyte for conducting ion between the air electrode and the anode; and a housing incorporating the power section, a hydrogen-detecting means being provided in the housing.

### TECHNICAL FIELD

The present invention relates to an air battery.

### BACKGROUND ART

An air battery is a battery employing oxygen as a cathode active material; at the time of discharge, air is introduced from outside the battery. So, compared with other type of batteries which incorporate active materials for both cathode and anode, it is possible to enlarge the occupancy rate of the anode active material in the battery case. Hence, in principle, such an air battery has features that dischargeable electric power is large; besides, downsizing and weight saving can be easily attained. In addition, oxidation power of oxygen to be employed as the cathode active material is strong, so the electromotive force is relatively high. Moreover, since oxygen is a clean resource whose amount is not limited, the air battery is environmentally-friendly. As above, air battery has many advantages; therefore it is expected to be used for batteries for, for example, hybrid cars and mobile devices.

With regard to an air battery using a metal as the anode, when water enters into the battery in emergency situations, there is a possibility of reaction of the water with the metal. If the water and the metal react, it is predicted that the air battery may be deteriorated. Therefore, to inhibit deterioration of the air battery, it is presumably important to detect entering of water into the air battery as early as possible.

As a technique related to such an air battery, for example, Patent document 1 discloses an air battery in which low-voltage alarm sounds when the detected voltage becomes equal to or less than the threshold level. In addition, Patent document 2 discloses a ventilation system for a metal-air battery comprising: a pipeline for supplying reaction air to an air battery cell; and a fan operative to circulate air for reaction.
Patent Document 1: Japanese Patent Application Laid-Open (JP-A) No. 2000-209787
Patent Document 2: Japanese Patent No. 3051455

### DISCLOSURE OF THE INVENTION

### Problems to be solved by the Invention

With the technique disclosed in the Patent document 1, since the low-voltage alarm sounds when the detected voltage becomes equal to or less than the threshold level, it is possible to easily find out whether or not the voltage of the air battery is equal to or less than the threshold level. However, the operating voltage of the air battery does not vary even when water enters into the air battery. Due to this, by the technique disclosed in the Patent document 1, it is difficult to detect entering of water into the air battery at an early point. It is also difficult to solve this problem even by simply combining the techniques of the Patent documents 1 and 2.

Accordingly, an object of the present invention is to provide an air battery which is capable of detecting entering of water at an early point.

### Means for Solving the Problems

In order to solve the above problem, the present invention takes the following means. In other words, the present invention is an air battery comprising: a power section which comprises an air electrode to which an oxygen-containing gas is supplied, an anode containing an alkali metal, and an electrolyte layer containing an electrolyte for conducting ion between the air electrode and the anode; and a housing incorporating the power section, a hydrogen-detecting means being provided in the housing.

In the invention, the configuration of the “hydrogen-detecting means” is not particularly limited as long as the means can detect hydrogen produced by reaction of an alkali metal with water entered into the housing. Examples of the hydrogen-detecting means of the present invention include: a contact burning-type hydrogen sensor, semiconductor hydrogen sensor, and micro-thermoelectric hydrogen sensor.

In the invention, the housing preferably seals the oxygen-containing gas.

Moreover, in the invention, preferably, the housing incorporates a flow path configured to guide the oxygen-containing gas which has not been used in the air electrode to the air electrode, wherein the flow path is provided with the hydrogen-detecting means.

Further, in the above invention in which the housing incorporates a flow path configured to guide the oxygen-containing gas which has not been used in the air electrode to the air electrode, the flow path is preferably a pipeline.

Still further, the housing preferably incorporates a plurality of the power sections.

### Effects of the Invention

The air battery of the present invention is provided with a hydrogen-detecting means. So, it is possible to detect hydrogen produced by reaction of an alkali metal with water entered into the battery by the hydrogen-detecting means. Since entering of water into the battery can be detected at an early point by detecting hydrogen, with the present invention, it is possible to provide an air battery which is capable of detecting entering of water at an early point.

In addition, in the invention, as the oxygen-containing gas is sealed by the housing, it is possible to detect hydrogen at an early point. Accordingly, with this configuration, early detection of entering of water can be easier.

Further, in the invention, when the housing incorporates a flow path (for example, a pipeline) configured to guide the oxygen-containing gas which has not been used in the air electrode to the air electrode, by disposing the hydrogen-detecting means in the flow path, it is possible to detect entering of water at an early point.

Still further, in the invention, since the housing incorporates a plurality of the power sections, water entering into one or more of the plurality of the power sections can be detected at an early point.

### BRIEF DESCRIPTION OF THE DRAWINGS

FIG. 1 is a cross-sectional view showing an embodiment of an air battery 10;

FIG. 2 is a cross-sectional view showing an embodiment of an air battery 20;

FIG. 3 is a cross-sectional view showing an embodiment of an air battery 30;

FIG. 4 is a cross-sectional view showing an embodiment of an air battery 40;

FIG. 5 is a cross-sectional view showing an embodiment of an air battery 50; and

FIG. 6 is a cross-sectional view showing an embodiment of an air battery 60.

### DESCRIPTION OF THE REFERENCE NUMERALS

1 air electrode
2 anode
3 electrolyte layer
4 power section
5 oxygen layer
6 housing
7 hydrogen sensor (hydrogen-detecting means)
8 space
9 output means
10 air battery
20 air battery
21 housing
22 electrolytic solution
23 stacked structure
24 oxygen layer
25 oxygen flow path
26 space
30 air battery
31 flow path
32 stacked structure
33 housing
34 inlet port (oxygen inlet port)
35 outlet port (oxygen outlet port)
36 air electrode
37 anode
40 air battery
41 flow path
42 pipeline
43 housing
50 air battery
51 flow path
51x flow path
52 housing
53 inlet port (oxygen inlet port)
54 outlet port (oxygen outlet port)
60 air battery
61 case

### BEST MODE FOR CARRYING OUT THE INVENTION

When water enters into the power section of an air battery in emergency situations, the air battery is deteriorated. However, it is difficult for the air batteries proposed in the past to detect entering of water at an early point. As a result of the intensive study by the inventors, they discovered that with a configuration where a hydrogen-detecting means is provided in a housing, it is possible to detect hydrogen produced by reaction of alkali metal in the power section with the entered water; thereby possible to detect entering of water at an early point. By detecting entering of water at an early point, it is assumed that deterioration of the air battery can be inhibited.

The present invention has been completed based on this finding and the main object is to provide an air battery which is capable of detecting entering of water at an early point.

Hereinafter, the present invention will be described with reference to the drawings. It should be noted that the embodiments shown below are examples of the present invention, so that the invention is not limited by these embodiments.

### 1. The First Embodiment

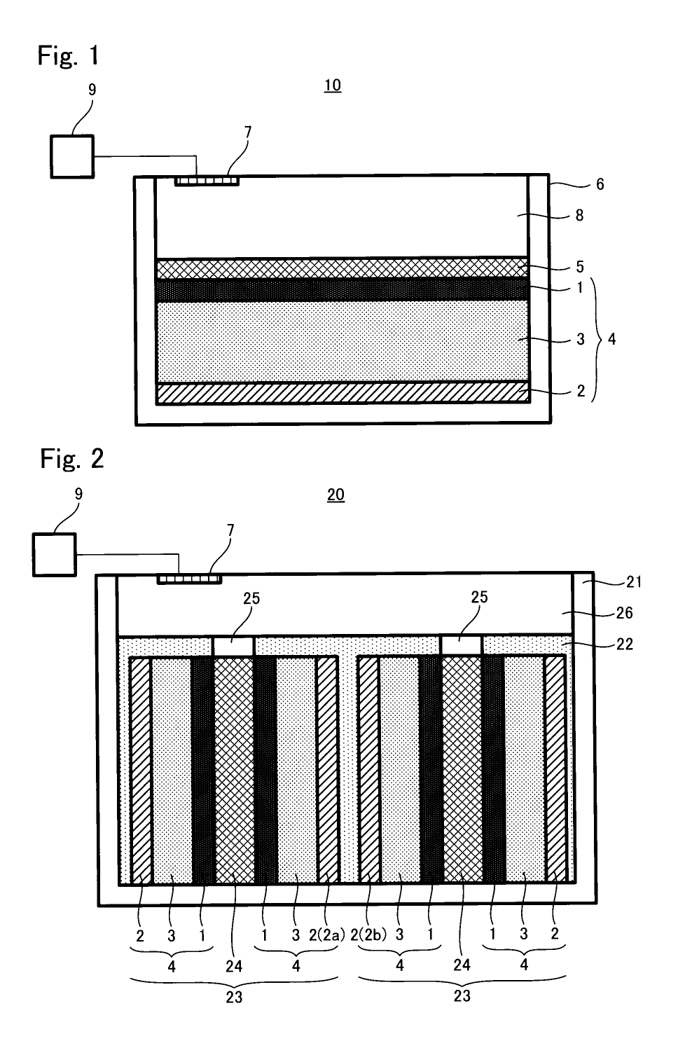

FIG. 1 is a cross-sectional view schematically showing an embodiment of an air battery 10 according to the present invention. As shown in FIG. 1, the air battery 10 comprises: a power section 4 which comprises an air electrode 1, an anode 2, and an electrolyte layer 3 disposed between the air electrode 1 and the anode 2; an oxygen layer 5 disposed on the air electrode 1 side of the power section 4; and a housing 6 incorporating the power section 4 and the oxygen layer 5. Inside the housing 6, a hydrogen-detecting means 7 (hereinafter, referred to as “hydrogen sensor 7”.) is disposed at an upper side in relation to the anode 2, wherein the hydrogen sensor 7 is connected to an output means 9 which outputs electronic signals when hydrogen concentration exceeds the threshold level. In the air battery 10, the anode 2 contains a substance which is capable of emitting or absorbing/emitting ion of an alkali metal (i.e. a simple substance or compound of alkali metal. Hereinafter, referred to as “alkali metal”.). In addition, in the space 8 provided between the top face of the housing 6 and the oxygen layer 5, an oxygen-containing gas is filled.

When water entered into the housing 6 in emergency situations reacts with an alkali metal contained in the anode 2, hydrogen is produced. For instance, when the anode 2 contains lithium, reaction of the lithium with water produces hydrogen and LiOH. The hydrogen thus produced diffuses upwardly. As above, inside the housing 6, the hydrogen sensor 7 is disposed at an upper side in relation to the anode 2. So, with the air battery 10, by using the hydrogen sensor 7, it is possible to detect the hydrogen produced by the reaction of water entered into the housing 6 with the alkali metal contained in the anode 2. The detection result by the hydrogen sensor 7 will then be outputted to the output means 9. As described above, the output means 9 outputs electronic signals when the hydrogen concentration exceeds the threshold level; therefore, with the air battery 10, it is possible to detect water entering into the housing 6 at an early point with the electronic signals outputted by the output means 9. Accordingly, with the air battery 10, it is possible to detect entering of water into the housing 6 at an early point. Therefore, by the air battery 10, it is possible to inhibit deterioration, abnormality, and runaway of the battery. The air battery 10 will be described as follows on the element basis.

### <Air Electrode 1>

The air electrode 1 contains an electroconductive material, a catalyst, and a binder for binding the electroconductive material and the catalyst.

The electroconductive material contained in the air electrode 1 is not particularly restricted as long as it can endure the operation environment of the air battery 10 and as long as it has electrical conductivity. Examples of the electroconductive material contained in the air electrode 1 include carbon materials such as carbon black and mesoporous carbon. In addition, to inhibit decrease of reaction field and battery capacity, the content of the electroconductive material in the air electrode 1 is preferably 10 mass % or more. Moreover, to have a configuration which can attain sufficient catalytic function, the content of the electroconductive material in the air electrode 1 is preferably 99 mass % or less.

Examples of catalyst contained in the air electrode 1 include cobalt phthalocyanine and manganese dioxide. To have a configuration which can attain sufficient catalytic function, the content of the catalyst in the air electrode 1 is preferably 1 mass % or more. Moreover, to inhibit decrease of reaction field and battery capacity, the content of the catalyst in the air electrode 1 is preferably 90 mass % or less.

Examples of the binder contained in the air electrode 1 include polyvinylidene fluoride (PVDF) and polytetrafluoroethylene (PTFE). The content of the binder in the air electrode 1 is not specifically restricted; for example, it is preferably 10 mass % or less, more preferably 1-5 mass %. The air electrode 1 can be produced by, for example, a method of coating a paint (which consists of: carbon black; a catalyst; and a binder) on the surface of below-described air electrode current collector by using doctor-blade method. Other than this, the air electrode 1 may also be produced by thermocompression of a mixed powder containing carbon black and a catalyst.

### <Anode 2>

The anode 2 contains an alkali metal which functions as an anode active material. The anode 2 is provided with an anode current collector (not shown) which is in contact with the inner or outer face of the anode 2 to collect the current of the anode 2.

Examples of the simple substance of the alkali metal to be contained in the anode 2 include: Li, Na, and K. Examples of the alkali metal compound to be contained in the anode 2 may be a lithium alloy. When the air battery 10 is a lithium-air secondary battery, in view of providing an air battery 10 which can easily attain high capacity, Li is preferably contained.

The anode 2 is not particularly limited as long as it contains at least an anode active material; it may also contain an electroconductive material for improving the conductivity and a binder for fixing the alkali metal and so on. To inhibit decrease of reaction field and battery capacity, the content of the electroconductive material in the anode 2 is preferably 10 mass % or less. The content of the binder in the anode 2 is not particularly limited; for example, it is preferably 10 mass % or less, more preferably 1-5 mass %. Types and content of the electroconductive material and the binder to be contained in the anode 2 can be the same as those of the air electrode 1.

In the air battery 10, the anode 2 is provided with an anode current collector which is in contact with the inner or outer face of the anode 2. The anode current collector has a function to collect the current of the anode 2. In the air battery 10, the material of the anode current collector is not particularly limited as long as it has electrical conductivity. Examples of the material for the anode current collector include: copper, stainless steel, and nickel. The shape of the anode current collector may be in a form of foil, plate, and mesh (grid). In the air battery 10, the anode 2 can be produced by, for example, the same method as that of the air electrode 1.

### <Electrolyte Layer 3>

The electrolyte layer 3 is filled with an electrolyte (liquid or solid) which conducts ions (alkali metal ion) between the air electrode 1 and the anode 2.

When a liquid electrolyte (electrolytic solution) is used for the electrolyte layer 3, the type of the electrolytic solution is not specifically restricted as long as it has metal ion conductivity; for example, there may be a non-aqueous electrolytic solution. The types of the non-aqueous electrolytic solution to be used for the electrolyte layer 3 are adequately selected depending on the types of conducting metal ions. For instance, the non-aqueous electrolytic solution of the lithium-air battery usually contains a lithium salt and an organic solvent. Examples of lithium salt include: inorganic lithium salts such as LiPF₆, LiBF₄, LiClO₄, and LiAsF₆; and organic lithium salts such as LiCF₃SO₃, LiN(CF₃SO₂)₂, LiN(C₂F₅SO₂)₂, and LiC(CF₃SO₂)₃. Examples of the organic solvent include: ethylene carbonate (EC), propylene carbonate (PC), dimethyl carbonate (DMC), diethyl carbonate (DEC), ethylmethyl carbonate (EMC), butylene carbonate, γ-butyrolactone, sulfolane, acetonitrile, 1,2-dimethoxymethane, 1,3-dimethoxypropane, diethylether, tetrahydrofuran, 2-methyltetrahydrofuran, and the mixture thereof. In view of a mode where the dissolved oxygen can be used efficiently in the reaction, the organic solvent is preferably a solvent having high oxygen solubility. Concentration of the lithium salt in the non-aqueous electrolytic solution is, for example, 0.2-3 mol/L. In the air battery of the present invention, for example, a low-volatile liquid such as ionic liquid can be used as the non-aqueous electrolytic solution.

In addition, when an electrolytic solution is used for the electrolyte layer 3, the electrolyte layer 3 preferably has a configuration in which an electrolytic solution is held in a separator. Examples of the separator include: porous membranes formed of, for example, polyethylene and polypropylene; nonwoven fabrics such as resin-made nonwoven fabric and glass fiber nonwoven cloth.

### <Oxygen Layer 5>

The oxygen layer 5 has a function to guide an oxygen-containing gas existing in the housing 6 to the air electrode 1. The oxygen layer 5 is a pathway of air to be guided to the air electrode 1; for example, a hole which is provided to the air electrode current collector for collecting electric current of the air electrode 1 in a manner to contact with the inner face or outer face of the air electrode 1 functions as the oxygen layer 5. In other words, the oxygen layer 5 can be called an air electrode current collector 5.

In the air battery 10, the air electrode current collector has a function to collect the current of the air electrode 1. In the air battery 10, the material of the air electrode current collector is not particularly limited as long as it has electrical conductivity. Examples of the material for the air electrode current collector include: stainless steel, nickel, aluminum, iron, titanium, and carbon. The shape of such an air electrode current collector may, for example, be in a form of mesh (grid).

### <Housing 6>

The housing 6 at least incorporates: a power section 4, an oxygen layer 5, a hydrogen sensor 7, and an oxygen-containing gas. In the air battery 10, the shape of the housing 6 is not specifically limited. The material constituting the housing 6 may be a material usable for the housing of a metal-air battery. The oxygen-containing gas received in the housing 6 (i.e. existing in the space 8.) may be, for example, an oxygen gas of which pressure is 1.01×10⁵ Pa and oxygen concentration is 99.99%.

### <Hydrogen Sensor 7>

The hydrogen sensor 7 is an element which detects hydrogen produced by reaction of water entered into the housing 6 with the alkali metal contained in the anode 2 and then output S the detection results to the output means. In the air battery 10, the hydrogen sensor 7 is not particularly limited as long as it can attain the function; a known hydrogen sensor such as a contact burning-type hydrogen sensor, a semiconductor hydrogen sensor, and a micro-thermoelectric hydrogen sensor can be used.

### <Output Means 9>

The output means 9 is connected to the hydrogen sensor 7 with or without wires. When the hydrogen concentration detected by the hydrogen sensor 7 exceeds the threshold level, the output means 9 outputs electronic signals. In the air battery 10, with the electronic signals outputted by the output means 9, it is possible to find out the entering of water into the housing 6 at an early point.

The above description related to the air battery 10 shows an embodiment where the power section 4 and the air are separated by the upper face of the housing 6 and the power section 4 is not opened to the air. However, the air battery of the present invention is not limited to this embodiment. The housing of the air battery of the invention may have a configuration where the upper lid is not provided. It should be noted that, in view of providing an air battery which can easily detect the generated hydrogen at an early point, a mode where the power section 4 is not open to the air is preferable. Other than this, for example, when an electrolytic solution is used for the electrolyte layer 3, in view of providing a configuration which is capable of inhibiting depletion of the electrolytic solution, an embodiment where the power section 4 is not opened to the air is preferable.

### 2. The Second Embodiment

FIG. 2 is a cross-sectional view schematically showing an embodiment of the air battery 20 according to the present invention. In FIG. 2, to the elements having the same structure as those in the air battery 10, the same reference numerals as those used in FIG. 1 are given and the explanation thereof is omitted.

As shown in FIG. 2, the air battery 20 comprises: a housing 21; an electrolytic solution 22; stacked structures 23, 23 which are disposed in the electrolytic solution 22. In the inner wall of the housing 21, a hydrogen sensor 7 is disposed at an upper side in relation to the electrolytic solution 22. In the air battery 20, the hydrogen sensor 7 is connected to the output means 9 outputting the electronic signals when hydrogen concentration exceeds the threshold level. There is a closed space inside the housing 21 and an oxygen-containing gas is filled in the space 26 between the upper face of the housing 21 and the electrolytic solution 22. The stacked structure 23 of the air battery 20 has a structure where the power sections 4, 4 are symmetrically arranged with respect to the oxygen layer 24. The oxygen-containing gas filled in the space 26 diffuses into the oxygen layers 24, 24 through the oxygen flow paths 25, 25 which connects the oxygen layer 24, 24 to the space 26.

In the air battery 20, when water entered into the housing 21 in emergency situations reacts with an alkali metal contained in the anodes 2, 2, . . . arranged in the electrolytic solution 22, hydrogen is produced. The hydrogen thus produced reaches the space 26 at an upper side in relation to the electrolytic solution 22 through the electrolytic solutions 22 contacting the anodes 2, 2, . . . . As described above, in the inner wall of the housing 21, the hydrogen sensor 7 is disposed at an upper side in relation to the electrolytic solution 22. Because of this, by the hydrogen sensor 7, hydrogen which has reached the space 26 can be detected. Then, the detection results by the hydrogen sensor 7 are outputted to the output means 9. As described above, the output means 9 outputs electronic signals when hydrogen concentration exceeds the threshold level. Due to this, in the air battery 20, by using the electronic signals outputted by the output means 9, it is possible to detect the entering of water into the housing 21 at an early point. Accordingly, with the air battery 20, it is possible to inhibit deterioration, abnormality, and runaway of the battery. The air battery 20 will be described as follows on the element basis.

### <Housing 21>

The housing 21 at least incorporates: an electrolytic solution 22; stacked structures 23, 23, . . . ; a hydrogen sensor 7; and an oxygen-containing gas. In the air battery 20, the shape of the housing 21 is not particularly limited as long as it has a structure which is capable of sealing inside the housing 21 to inhibit depletion of the electrolytic solution 22. The material constituting the housing 21 may be the same as that of the housing 6. The oxygen gas received in the housing 21 (i.e. existing in the space 26.) may be, for example, an oxygen gas of which pressure is 1.01×10⁵ Pa and oxygen concentration is 99.99%.

### <Electrolytic Solution 22>

The electrolytic solution 22 has a function to conduct ions between the air electrodes 1, 1, . . . and the anodes 2, 2, . . . . Specific examples of the electrolytic solution 22 may be the ones equivalent to an electrolytic solution usable for the electrolyte layer 3.

### <Stacked Structure 23>

The stacked structure 23 has a structure where the power sections 4, 4, are symmetrically arranged with respect to the oxygen layer 24. With this configuration, power (power density) per unit volume of the stacked structure 23 can be easily improved. In the air battery 20, the air electrodes 1, 1, . . . and the anodes 2, 2, . . . respectively composing the power sections 4, 4, . . . arranged in the electrolytic solution 22 may be electrically-connected in series or in parallel. In any connecting ways, once hydrogen is produced by reaction of water with one of the anodes 2 or a plurality of the anodes 2, 2, . . . , the hydrogen thus produced reaches the space 26 through the electrolytic solution 22; thereby it is possible to detect the hydrogen by the hydrogen sensor 7.

### <Oxygen Layer 24>

The oxygen layer 24 has a function to guide the oxygen-containing gas supplied through the below-described oxygen flow path 25 to the air electrodes 1, 1. The oxygen layer 24 is a pathway of air to be guided to the air electrodes 1, 1; for example, a hole which is provided to the air electrode current collector for collecting electric current of the air electrodes 1, 1 in a manner to contact with the outer face of the air electrodes 1, 1 functions as the oxygen layer 24. In other words, the oxygen layer 24 can be called an air electrode current collector 24.

### <Oxygen Flow Path 25>

The oxygen flow path 25 is a pathway of oxygen to guide the oxygen-containing gas existing in the space 26 to the oxygen layer 24. The shape of the oxygen flow path 25 is not particularly limited as long as it can attain the above function. The oxygen flow path 25 can be, for example, formed of a tubular member formed of a material equivalent to that of the housing 21.

In the above description regarding the air battery 20, an embodiment where the stacked structures 23, 23 are arranged at an interval is shown. However, the air battery of the invention is not limited to the embodiment, it may have other configurations where the anode 2a and the anode 2b in FIG. 2 contact with each other or where the anode 2a and the anode 2b are formed by a single member (namely, the stacked structures 23, 23 are integrally formed.).

### 3. The Third Embodiment

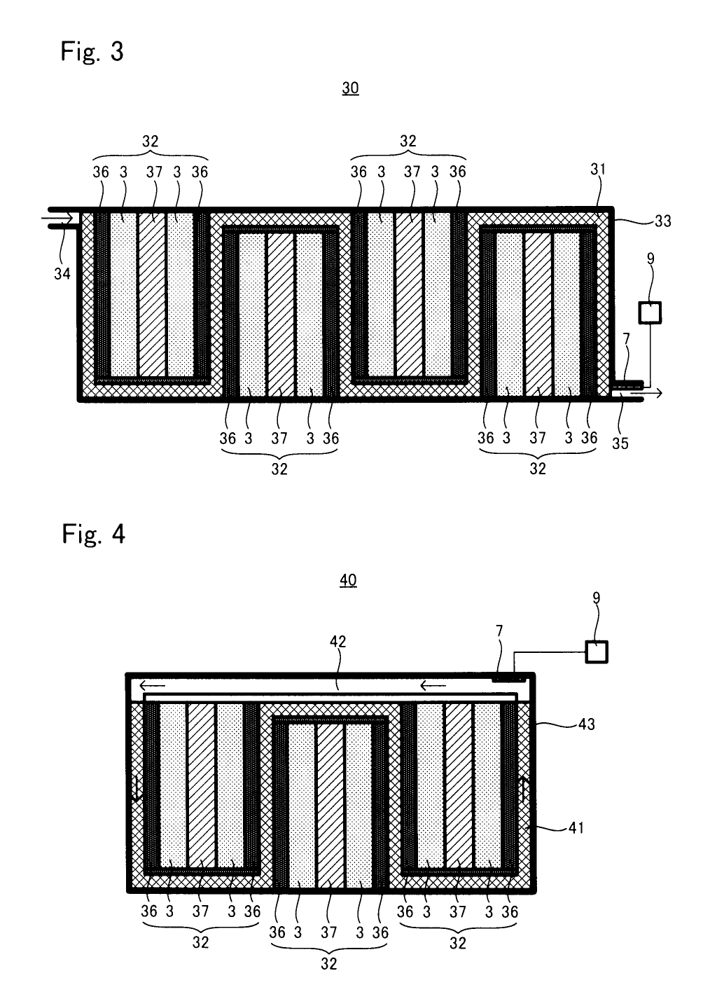

FIG. 3 is a cross-sectional view schematically showing an embodiment of the air battery 30 of the present invention. The arrows in FIG. 3 show flow direction of the oxygen-containing gas. In FIG. 3, to the elements having the same structure as those in the air battery 10, the same reference numerals as those used in FIG. 1 are given and the explanation thereof is omitted.

As shown in FIG. 3, the air battery 30 comprises: a flow path 31 to make the oxygen-containing gas path through; stacked structures 32, 32, . . . ; and a housing 33 incorporating them. The housing 33 comprises: an inlet port 34 of the oxygen-containing gas (hereinafter, referred to as “oxygen inlet port 34”.); and an outlet port 35 of the oxygen-containing gas (hereinafter, referred to as “oxygen outlet port 35”.). In the inner wall of the oxygen outlet port 35 provided to the housing 33, a hydrogen sensor 7 is disposed. The hydrogen sensor 7 is connected to an output means 9 which outputs electronic signals when hydrogen concentration exceeds the threshold level. The stacked structure 32 comprises: air electrodes 36, 36 disposed at the right-and-left ends; the anode 37 disposed in the center; and the electrolyte layers 3, 3 respectively arranged between the anode 37 and each of the air electrodes 36, 36, wherein the air electrodes 36, 36 and the anode 37 respectively contact with the electrolyte layers 3, 3. In the air battery 30, the air electrodes 36, 36, . . . contact with the flow path 31; the oxygen-containing gas passing through the flow path 31 is supplied to the air electrodes 36, 36, . . . .

When water entering into the housing 33 in emergency situations reacts with simple substance or compounds of an alkali metal contained in the anodes 37, 37, . . . , hydrogen is produced. As above, in the air battery 30, the anodes 37, 37, . . . and the electrolyte layers 3, 3, . . . are in contact with each other. Then, the air electrodes 36, 36, . . . contacting with the electrolyte layers 3, 3, . . . are in contact with the flow path 31. So, for example, when one anode 37 incorporated in the housing 33 and water react to produce hydrogen, the hydrogen reaches the flow path 31 through the electrolyte layer 3 being in contact with the anode 37 which has reacted with water and the air electrode 36 being in contact with the electrolyte layer 3. As described above, in the air battery 30, the hydrogen sensor 7 is disposed at the oxygen outlet port 35 of the housing 33 (more precisely, the inner wall of the oxygen outlet port 35) equivalent to an outlet port of the oxygen-containing gas passing through the flow path 31. Since the hydrogen diffuses towards the oxygen outlet port 35 together with the oxygen-containing gas also passing through the flow path 31, with the air battery 30, it is possible to detect hydrogen produced in the housing 33 by using the hydrogen sensor 7. The detection results by the hydrogen sensor 7 are then outputted to the output means 9. As described above, the output means 9 outputs electronic signals when the hydrogen concentration exceeds the threshold level. Because of this, with the air battery 30, it is possible to detect entering of water into the housing 33 at an early point with the electronic signals outputted by the output means 9. Accordingly, with air battery 30, it is possible to inhibit deterioration, abnormality, and runaway of the battery. The above description explained a case where one anode 37 and water react; however, even if water reacts with two or more anodes 37, 37, . . . incorporated in the housing 33, in the same manner as above, it is possible to detect hydrogen by the hydrogen sensor 7. The air battery 30 will be described as follows on the element basis.

### <Flow Path 31>

The flow path 31 is a passage of oxygen-containing gas to be guided to the air electrodes 36, 36, . . . . The flow path 31 is formed of, for example, a porous material which does not react with an electrolytic solution provided in the electrolyte layers 3, 3, . . . or a mesh-type tubular member. The oxygen-containing gas which passes through the flow path 31 may be, for example, the one having a pressure of 1.01×10⁵ Pa and an oxygen concentration of 99.99%.

### <Stacked Structure 32>

The stacked structure 32 comprises: air electrodes 36, 36 disposed at the right-and-left ends; an anode 37 disposed in the center; and an electrolyte layers 3, 3 respectively arranged between the anode 37 and each of the air electrodes 36, 36, wherein the air electrodes 36, 36 and the anode 37 respectively contact with the electrolyte layers 3, 3. With this configuration, power (power density) per unit volume of the stacked structure 32 can be easily improved. In the air battery 30, the air electrodes 36, 36, . . . and the anodes 37, 37, . . . may be electrically-connected in series or in parallel. In any connecting ways, it is possible to detect entering of water into the housing 33 at an early point by the hydrogen sensor 7 disposed in the oxygen outlet port.

### <Housing 33>

The housing 33 at least incorporates: a flow path 31; stacked structures 32, 32, . . . ; and a hydrogen sensor 7, and further comprises: an oxygen inlet port 34 as an inlet port for oxygen passing through the flow path 31; and an oxygen outlet port 35 as an outlet port for oxygen having passed through the flow path 31. The material constituting the housing 33 may be the same as that of the housing 6.

### <Air Electrode 36>

The air electrode 36 contains: an electroconductive material, a catalyst, and a binder for binding the electroconductive material and the catalyst. The air electrode 36 is provided with an air electrode current collector (not shown) which is in contact with the inner or outer face of the air electrode 36 to collect the current of the air electrode 36. The types and content of the electroconductive material, the catalyst, and the binder to be contained in the air electrode 36 may be the same as those of the air electrode 1.

### <Anode 37>

The anode 37 contains an alkali metal which functions as an anode active material. The anode 37 is provided with an anode current collector (not shown) which is in contact with the inner or outer face of the anode 37 to collect the current of the anode 37. The material constituting the anode 37 may be the same as that of the anode 2.

### 4. The Fourth Embodiment

FIG. 4 is a cross-sectional view schematically showing an embodiment of an air battery 40. The arrows in FIG. 4 show flow direction of the oxygen-containing gas. In FIG. 4, to the elements having the same structure as those in the air battery 30, the same reference numerals as those used in FIG. 3 are given and the explanation thereof is omitted.

As shown in FIG. 4, the air battery 40 comprises: a flow path 41 to make the oxygen-containing gas path through; stacked structures 32, 32, . . . ; a pipeline 42 configured to guide an oxygen-containing gas existing in the oxygen-containing gas most downstream area of the flow path 41 to the oxygen-containing gas most upstream area of the flow path 41; and a housing 43 incorporating them. The air battery 40 further comprises a circulating means (for example, circulation pump; not shown.) configured to circulate the oxygen-containing gas passing through the flow path 41 and the pipeline 42. In the inner periphery of the pipeline 42, a hydrogen sensor 7 is disposed in the vicinity of the oxygen-containing gas most downstream area of the flow path 41. The hydrogen sensor 7 is connected with the output means 9 outputting electronic signals when the hydrogen concentration exceeds the threshold level.

Similar to the air battery 30, in the case of the air battery 40, the hydrogen produced by reaction of water entered into the housing 43 with one anode 37 or a plurality of the anodes 37, 37, . . . incorporated in the housing 43 moves into the flow path 41. Then, the hydrogen reaches oxygen-containing gas most downstream area of the flow path 41 together with oxygen-containing gas passing through the flow path 41. As described above, in the inner periphery of the pipeline 42, the hydrogen sensor 7 is disposed in the vicinity of the oxygen-containing gas most downstream area of the flow path 41. Because of this, with the air battery 40, it is possible to detect hydrogen produced in the housing 43 by the hydrogen sensor 7 disposed in the inner periphery of the pipeline 42. The detection results by the hydrogen sensor 7 will then be outputted to the output means 9. As described above, the output means 9 outputs electronic signals when the hydrogen concentration exceeds the threshold level; therefore, with the air battery 40, it is possible to detect water entering into the housing 43 at an early point with the electronic signals outputted by the output means 9. Accordingly, with the air battery 40, it is possible to inhibit deterioration, abnormality, and runaway of the battery. The air battery 10 will be described as follows on the element basis.

### <Flow Path 41>

The flow path 41 is a passage of oxygen-containing gas to be guided to the air electrodes 36, 36, . . . . The flow path 41 is formed of, for example, a porous material which does not react with an electrolytic solution provided in the electrolyte layers 3, 3, . . . or a mesh-type tubular member. The oxygen-containing gas which passes through the flow path 41 may be, for example, the one having a pressure of 1.01×10⁵ Pa and an oxygen concentration of 99.99%.

### <Pipeline 42>

The pipeline 42 is a flow path of the oxygen-containing gas which guides an oxygen-containing gas existing in the oxygen-containing gas most downstream area of the flow path 41 to the oxygen-containing gas most upstream area of the flow path 41. In other words, the pipeline 42 is a flow path for guiding the oxygen-containing gas which has not been used at the air electrodes 36, 36, . . . provided at a plurality of the stacked structures 32, 32, . . . incorporated in the housing 43 to the air electrode 36 to which oxygen-containing gas passing the most upstream area of the oxygen-containing gas flow direction of the flow path 41 is supplied. In the inner periphery of the pipeline 42, a hydrogen sensor 7 is disposed at a position that is a downstream side in the oxygen-containing gas flow direction from the air electrode 36 to which an oxygen-containing gas passing the most downstream area in the oxygen-containing gas flow direction of the flow path 41 is supplied. With this configuration, it is possible to detect the hydrogen which has passed together with the oxygen-containing gas discharged from the air electrodes 36, 36, . . . by the hydrogen sensor 7; thereby possible to detect entering of water at an early point.

### <Housing 43>

The housing 43 at least incorporates: a flow path 41; stacked structures 32, 32, a pipeline 42; and a hydrogen sensor 7. The material constituting the housing 43 may be the same as that of the housing 6.

The above description regarding the air battery 40 shows an embodiment comprising the pipeline 42 as a flow path for guiding the oxygen-containing gas which has not been used in the air electrodes 36, 36, to the air electrodes 36, 36, . . . . However, the air battery of the present invention is not limited to the embodiment. The invention may have a flow path other than the pipeline (tubular flow path) as long as the flow path has a function to guide the oxygen-containing gas which has not been used in the air electrodes 36, 36, . . . to the air electrode 36, 36, . . . .

### 5. The Fifth Embodiment

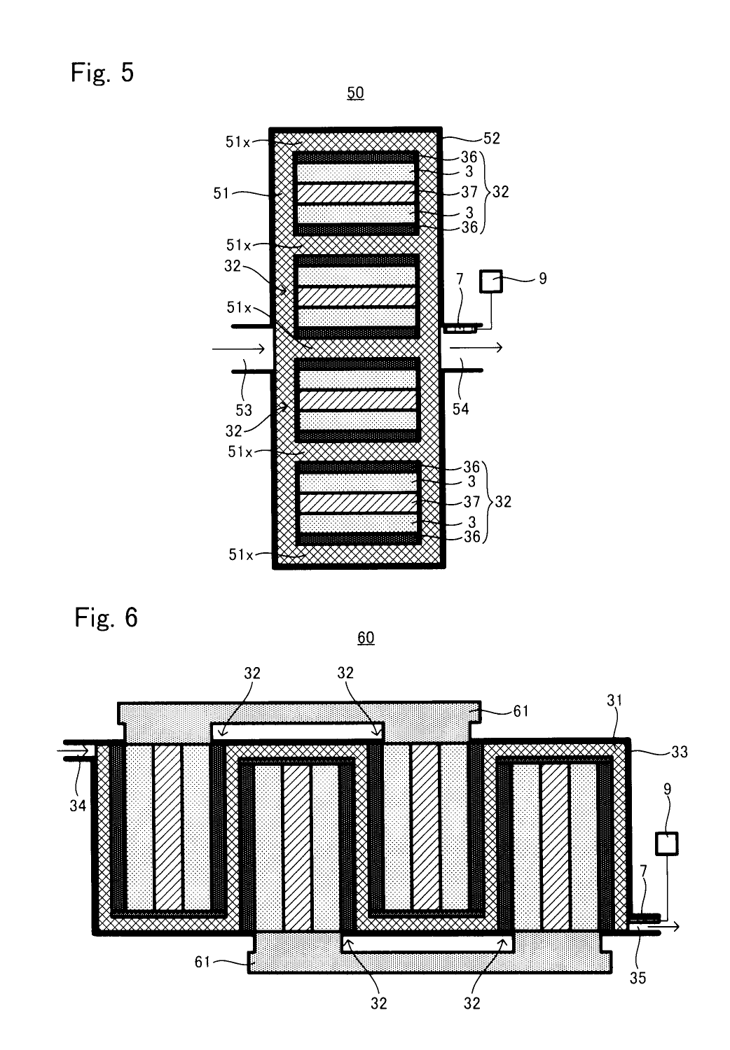

FIG. 5 is a cross-sectional view schematically showing an embodiment of the air battery 50 of the present invention. The arrows in FIG. 5 show flow direction of the oxygen-containing gas. In FIG. 5, to the elements having the same structure as those in the air battery 30, the same reference numerals as those used in FIG. 3 are given and the explanation thereof is omitted.

As shown in FIG. 5, the air battery 50 comprises: a flow path 51 to make the oxygen-containing gas path through; stacked structures 32, 32, . . . ; and a housing 52 incorporating them. The housing 52 comprises an inlet port 53 for oxygen-containing gas (hereinafter, referred to as “oxygen inlet port 53”.) and an outlet port 54 for oxygen-containing gas (hereinafter, referred to as “oxygen outlet port 54”.). In the inner wall of the oxygen outlet port 54 of the housing 52, a hydrogen sensor 7 is disposed. The hydrogen sensor 7 is connected to the output means 9 which outputs electronic signals when the hydrogen concentration exceeds the threshold level. In the air battery 50, the oxygen-containing gas which has entered into the housing 52 from the oxygen inlet port 53 is divided into flow paths 51x, 51x, . . . inside the housing 52 and then does pass through flow paths 51x, 51x, . . . . Thereafter, among the oxygen-containing gas which has passed through the flow paths 51x, 51x, . . . , an oxygen-containing gas which has not been used in the stacked structures 32, 32, . . . are discharged to outside the housing 52 through the oxygen outlet port 54.

Similar to the air battery 30 and the air battery 40, in the air battery 50, the hydrogen produced by reaction of water entered into the housing 52 with one anode 37 or a plurality of the anodes 37, 37, . . . incorporated in the housing 52 moves into the flow path 51. Then, the hydrogen reaches the oxygen outlet port 54 together with the oxygen-containing gas passing through the flow path 51. As described above, in the inner wall of the oxygen outlet port 54, the hydrogen sensor 7 is disposed. Because of this, with the air battery 50, it is possible to detect hydrogen produced in the housing 52 by the hydrogen sensor 7 disposed in the inner wall of the oxygen outlet port 54. The detection results by the hydrogen sensor 7 will then be outputted to the output means 9. As described above, the output means 9 outputs electronic signals when the hydrogen concentration exceeds the threshold level; therefore, with the air battery 50, it is possible to detect water entering into the housing 52 at an early point with the electronic signals outputted by the output means 9. Accordingly, with the air battery 50, it is possible to inhibit deterioration, abnormality, and runaway of the battery. The air battery 50 will be described as follows on the element basis.

### <Flow Path 51>

The flow path 51 is a passage of oxygen-containing gas to be guided to the air electrodes 36, 36, . . . . The flow path 51 is divided into a plurality of flow paths 51x, 51x, . . . along the way, and the divided flow paths 51x, 51x, . . . are integrated again. The stacked structures 32, 32, are respectively disposed between the flow paths 51x, 51x, . . . . The flow path 51 may be formed of, for example, a porous material which does not react with an electrolytic solution provided in the electrolyte layers 3, 3, . . . or a mesh-type tubular member. The oxygen-containing gas passing through the flow path 51 may be, for example, an oxygen gas of which pressure is 1.01×10⁵ Pa and oxygen concentration is 99.99%. With the air battery 50 having the flow path 51 of such a configuration, compared with the air battery 30 and the air battery 40, it is possible to reduce unevenness of the concentration in oxygen-containing gas to be supplied to each air electrode 36, 36, (oxygen concentration in the oxygen-containing gas).

### <Housing 52>

The housing 52 at least incorporates: the flow path 51; stacked structures 32, 32, . . . ; and the hydrogen sensor 7, the housing 52 further comprises: the oxygen inlet port 53 as an inlet port for oxygen passing through the flow path 51; and the oxygen outlet port 54 as an outlet port for oxygen which has passed through the flow path 51. The material constituting the housing 52 may be the same as that of the housing 6.

### 6. The Sixth Embodiment

FIG. 6 is a cross-sectional view schematically showing an embodiment of the air battery 6 of the present invention. The arrows in FIG. 6 show flow direction of the oxygen-containing gas. In FIG. 6, to the elements having the same structure as those in the air battery 30, the same reference numerals as those used in FIG. 3 are given and the explanation thereof is omitted.

As shown in FIG. 6, the air battery 60 is an embodiment where cases 61, 61 are added to the air battery 30. The case 61 is connected to four electrolyte layers 3, 3, . . . provided in two of the stacked structures 32, 32, wherein the case 61 is capable of supplying electrolytic solution to the electrolyte layers 3, 3, . . . . In the air battery 30, when an electrolytic solution is used for the electrolyte layers 3, 3, . . . , even if the electrolytic solution is kept in a separator, it is difficult to completely prevent volatilization of the electrolytic solution. So, so as to minimize the effect attributed to the decrease of electrolytic solution caused by the volatilization, the air battery 60 has a structure having the cases 61, 61. With this configuration, even when the electrolytic solution volatilizes and is lost from the electrolyte layers 3, 3, . . . , the electrolytic solution can be refilled from the cases 61, 61 to the electrolyte layers 3, 3, . . . . Due to this, with the air battery 60, in addition to the above effect obtained by the air battery 30, it is further possible to maintain the ionic conduction effect of the electrolyte over a long time. Hereinafter, the case 61 provided to the air battery 60 will be described.

### <Case 61>

The case 61 comprises an electrolytic solution to be supplied to the electrolyte layers 3, 3, . . . . The case 61 is provided with connecting ports used for connecting the case 61 to the side face of the housing 33. When the case 61 is mounted to the housing 33, the electrolytic solution can be supplied to the electrolyte layers 3, 3 through the connecting ports. The case 61 may be formed of a known material which does not react with the electrolytic solution.

The above descriptions regarding the air battery 60 shows an embodiment where the cases 61, 61 are added to the air battery 30; however, the air battery of the present invention is not limited to the embodiment. An embodiment where the cases 61, 61 are added to the air battery 40 or another embodiment where the cases 61, 61 are added to the air battery 50 may be possible.

The descriptions regarding the air batteries 30, 40, 50, and 60 show embodiments where an electrolytic solution is provided in the electrolyte layers 3, 3, . . . ; however, the air battery of the invention is not limited to them. The air battery of the invention may have an embodiment where a solid electrolyte is provided to the electrolyte layers 3, 3, . . . and the cases 61, 61.

Moreover, the above descriptions regarding the air batteries 10, 20, 30, 40, 50, and 60 (hereinafter, these are simply referred to as “air battery of the invention”.) show embodiments comprising the output means 9 together with the hydrogen sensor 7. However, the air battery of the invention is not limited to the embodiments; an embodiment where the output means 9 is not provided can be possible. It should be noted that, to have a configuration which is capable of easily detecting water entering into the housing, for example, an embodiment comprising the output means 9 together with the hydrogen sensor 7 is preferable.

Examples of types of the above described air battery of the present invention include: a lithium-air battery, a sodium-air battery, and a potassium-air battery. In view of providing an air battery with higher capacity, a lithium-air battery is preferable. In addition, examples of the usage of the air battery of the invention include: applications for vehicle, stationary power source, domestic power source, and portable information equipments.

As above, the air battery of the present invention having embodiments in which alkali metal is contained in the anode 2 and the anode 37 has been described; the technical ideas of the present invention can be applied to an air battery which is provided with an anode containing Group-II element (for example, Mg and Ca.).

### INDUSTRIAL APPLICABILITY

The air battery of the present invention can be used for, for example, power source of electric vehicles and a portable information equipment.

1. An air battery comprising: a power section which comprises an air electrode to which an oxygen-containing gas is supplied, an anode containing an alkali metal, and an electrolyte layer containing an electrolyte for conducting ion between the air electrode and the anode; and a housing incorporating the power section,
the electrolyte layer using a non-aqueous electrolytic solution and a hydrogen-detecting means being provided in the housing.

2. The air battery according to claim 1, wherein the housing seals the oxygen-containing gas.

3. The air battery according to claim 1, wherein the housing incorporates a flow path configured to guide the oxygen-containing gas which has not been used in the air electrode to the air electrode, wherein the flow path is provided with the hydrogen-detecting means.

4. The air battery according to claim 3, wherein the flow path is a pipeline.

5. The air battery according to claim 1, wherein the housing incorporates a plurality of the power sections.

6. The air battery according to claim 2, wherein the housing incorporates a flow path configured to guide the oxygen-containing gas which has not been used in the air electrode to the air electrode, wherein the flow path is provided with the hydrogen-detecting means.

7. The air battery according to claim 6, wherein the flow path is a pipeline.

8. The air battery according to claim 2, wherein the housing incorporates a plurality of the power sections.

9. The air battery according to claim 3, wherein the housing incorporates a plurality of the power sections.

10. The air battery according to claim 4, wherein the housing incorporates a plurality of the power sections.

11. The air battery according to claim 6, wherein the housing incorporates a plurality of the power sections.

12. The air battery according to claim 7, wherein the housing incorporates a plurality of the power sections.
